(19) United States
(12) Patent Application Publication
(10) Pub. No.: US 2018/0031153 A1
(43) Pub. Date: Feb. 1, 2018

(54) Method for Sealing Threaded Pipe Joints

(71) Applicant: Aleksey V. TOKAREV, St. Petersburg (RU)

(72) Inventors: Aleksey V. TOKAREV, St. Petersburg (RU); Pavel A. TOKAREV, St. Petersburg (RU); Vasily V. KOLESNICHENKO, St. Petersburg (RU)

(21) Appl. No.: 15/715,941

(22) Filed: Sep. 26, 2017

Related U.S. Application Data
(63) Continuation of application No. PCT/RU2016/000495, filed on Aug. 1, 2016.

(30) Foreign Application Priority Data
Dec. 28, 2015 (RU) 2015156657

(51) Int. Cl. F16L 15/04

(52) U.S. Cl. CPC F16L 15/04

(57) ABSTRACT

The method relates to pipe production. A method for sealing threaded pipe connections involves preparing the surface of a threaded connection in order to create a porous adhesion layer on the metal, applying a polymer coating with the addition of gamma-aminosilane in an amount comprising 1-15% by mass of the dry polymer residue, and filling the threaded space with a sealing material based on a composition of graphite and a copolymer of tetrafluoroethylene (TFE) and hexafluoropropylene (HFP). Prior to applying the polymer coating to the threaded surface of an item, a synthetic corrosion inhibitor is applied to the porous adhesion layer. The film of inhibitor acts to prevent corrosive processes from taking place on the surface of an item while using same in various climatic conditions, thus increasing corrosion resistance and also the reliability of the applied coating due to high adhesion between the layers thereof.

### RELATED APPLICATIONS

This Application is a Continuation application of International Application PCT/RU2016/000495, filed on Aug. 1, 2016, which in turn claims priority to Russian Patent Applications No. RU2015156657, filed Dec. 28, 2015, both of which are incorporated herein by reference in their entirety.

### FIELD OF THE INVENTION

The invention relates to the production of pipes and can be used for sealing threaded pipe joints including those applied in the construction of oil, gas and gas-condensate wells and in the assembling of pipe strings and pipelines.

### BACKGROUND OF THE INVENTION

Structural and manufacturing gaps in threaded joints of casing pipes caused by excessive internal or external pressure often lead to joint leakage and their permeability to a medium. To reduce joint permeability various fillers for structural and manufacturing gaps are used. The fillers simultaneously act as lubricants preventing seizure of wearing surfaces when screwing threaded joints.

The method for tightening and sealing threaded joints of thin-walled pipes according to the patent application RU 93010518 is known wherein a pipe thread before screwing-on a coupler is wrapped with a tape made of a capacitor film based on polytetrafluoroethylene (fluoroplast). Therefore the tightening procedure consists in wrapping the pipe thread with the tape tightly stretched around the thread profile. However, the above method does not provide the proper degree of joint sealing at multiple screwing operations.

The closest analogue to the claimed approach is the method for sealing threaded pipe joints described in patent RU 2543107. According to this method the surface of the threaded joint is prepared at first to form a porous adhesive corrosion-resistant layer on metal surface and then the threaded space is filled with a sealing material based on a composite material consisting of graphite and copolymer of tetrafluoroethylene (TFE) and hexafluoropropylene (HFP). Besides, before applying the sealing material to the threaded surface of the article a polymer material with added gamma-aminosilane in an amount of 1÷15% by mass fraction of solid polymer residue is applied to the porous corrosion-resistant layer and the composite material based on copolymer of tetrafluoroethylene (TFE) and hexafluoropropylene (HFP), graphite and fillers of the following composition (in parts by mass) is used as a sealing material:

copolymer of TFE and HFP 80÷99

graphite 1÷20

fillers 0÷15

However, as is seen from the results of the performed tests, the coatings prepared according to the method described in patent RU2543107 are susceptible to underfilm corrosion and self-peeling at low temperatures and high humidity, especially under long-term storage conditions.

### SUMMARY OF THE INVENTION

The object of the claimed invention is the development of a reliable and technologically simple process for sealing threaded pipe joints providing their leak tightness when frequently screwing as well as their coating integrity under long-term storage conditions of unheated premises.

The technical result provided by the claimed invention capable of solving the above problem consists in improving the corrosion resistance and the integrity of the applied coating due to a high degree of adhesion between its layers.

It is known that to prevent corrosion damage various corrosion inhibitors are usually used forming on metal surface a film in the form of compounds with metal ions. However, the use of some inhibitors for this purpose can decrease metal adhesion to the subsequently applied polymer coating. The results of the performed tests show that synthetic corrosion inhibitors, for example, such as N-M-1, AQUACOR-5115, Drewgard 120, etc., are most suitable for the purpose of the present invention.

On the basis of the object of the invention and the results of the performed tests the following technical solution is prepared:

According to the claimed method, as in the prototype, the surface of the threaded joint is prepared to form a porous adhesive layer on metal surface. A polymer coating with added gamma-aminosilane in an amount of 1÷15% by mass fraction of solid polymer residue is applied to this layer and the threaded space is filled with a sealing material based on a composite material consisting of graphite and copolymer of tetrafluoroethylene (TFE) and hexafluoropropylene (HFP) of the following composition (in parts by mass):

copolymer of TFE and HFP 80÷99

graphite 1÷20

fillers 0÷15

Besides, after preparing the porous adhesive layer on metal surface and before applying the polymer coating to the threaded surface of the article to improve its corrosion resistance this layer is coated with synthetic corrosion inhibitor forming a film preventing corrosion processes arising on the article surface when operating under various environmental conditions.

### BRIEF DESCRIPTION OF THE DRAWINGS

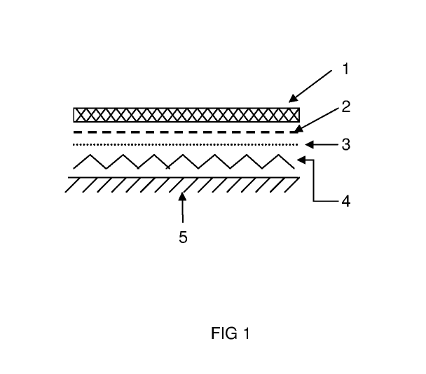

The essence of the invention is illustrated by figure (FIG. 1) which schematically shows cross-sectional view of the sealing coating of the threaded joint, prepared according to the claimed method, and leader lines show: 1—sealing material, 2—polymer coating, 3—film of synthetic inhibitor, 4—prepared porous surface layer, 5—surface of metal article

### DETAILED DESCRIPTION OF THE PREFERRED EMBODIMENTS

The claimed method is as follows:

The surface of the parts before spraying is degreased in soda ash solution or other alkaline degreasing solutions such as KM-1, KM-2.

After chemical degreasing the surface of the threaded joint is prepared to form a porous layer on the surface of the article. The surface is prepared using standard procedures, for example, surface phosphatizing, thermal diffusion galvanizing, chemical oxidation, etc.

Then the surface of the part is spray-coated with synthetic corrosion inhibitor, for example, in the form of 3% aqueous solution of N-M-1 inhibitor.

Subsequently the surface of the article (part) is spray-coated with a polymer primer with added gamma-aminosilane in an amount of 1÷1% by mass fraction of solid polymer residue.

Metallographic analysis of the sealing coating prepared according to the claimed method using synthetic inhibitors revealed the traces of the polymer coating diffusion into the porous metal surface spray-coated with the inhibitor. This indicates that the polymer coating forms strong adhesion bond with the porous inhibited layer of metal surface due to their chemisorption interaction.

After applying the polymer coating the sealing material of the following composition is spray-coated (in parts by mass):

copolymer of TFE and HFP 80÷99

graphite 1÷20

fillers 0÷15

The proposed composition can be prepared as follows.

The filler (graphite or the like) is introduced into TFE-HFP copolymer powder passed through 025-mesh sieve (mesh size 250×250 μm) and thoroughly mixed in Henschel mixer operating at speed of 2000÷3000 rpm.

TFE-HFP copolymer and fillers (graphite, boron nitride, talc) are produced on an industrial scale.

The prepared composite material is loaded into the hopper of electrostatic spraying installation of UENP type or any other type wherein composite powder charging and transporting in high-voltage electrostatic field (Uₒₚ=15÷100 kV, Iₒₚ=50÷100 μA) is provided. Charged particles of the composite material are deposited on the earthed part (the inner surface of the threaded joint) in solid layer whereupon the part is placed into electric oven wherein the composite powder is melted at 320÷380° C. forming a glossy coating (black or white, depending on the filler used) tightly bounded to the porous layer of metal, primer and sealing coating providing a reliable joint sealing.

The results of the performed tests show that when screwing threaded pipe joints the sealing coating is saved and can be used multiple times—more than 30 times.

The proposed method significantly improves the sealing quality and the corrosion resistance of the threaded pipe joints and therefore provides conditions wherein the articles being assembled in various operation and field environment do not require additional joint sealing since it has already been made during manufacturing process using automated equipment.

### INDUSTRIAL APPLICABILITY

As mentioned above the invention is intended for sealing threaded pipe joints as it follows from the object of the invention specified in its title.

Besides, the application discloses all the facilities and operations required for the implementation of the invention as described in the claims.

What is claimed is:

1. A method for sealing a threaded pipe joint comprising:
preparing a surface of a threaded joint to form a porous adhesive layer on the surface;
coating the porous adhesive layer with a synthetic corrosion inhibitor;
applying a polymer coating with added gamma-aminosilane in an amount of 1÷15% of a mass fraction of a solid polymer residue; and
filling a threaded space of the threaded joint with a sealing material, the sealing material being based on a composition of graphite and a copolymer of tetrafluoroethylene (TFE) and hexafluoropropylene (HFP), the composition consisting of (by mass):
copolymer of TFE and HFP 80÷99
graphite 1÷20
fillers 0÷15.
